(19) United States
(12) Patent Application Publication
(10) Pub. No.: US 2014/0027095 A1
(43) Pub. Date: Jan. 30, 2014

(54) SCREW AND METHOD FOR PRODUCING SAME

(71) Applicants: Gerd Warchol, Linz (AT); Lutz Kebelmann, Insel Poel (DE)

(72) Inventors: Gerd Warchol, Linz (AT); Lutz Kebelmann, Insel Poel (DE)

(73) Assignee: M.E.E. GMBH, Schwerin (DE)

(21) Appl. No.: 14/006,181

(22) PCT Filed: Mar. 7, 2012
(86) PCT No.: PCT/EP2012/001004

§ 371 Date: Oct. 3, 2013

(30) Foreign Application Priority Data
Mar. 19, 2011 (DE) 10 2011 014 474.9

(51) Int. Cl. B29C 47/60

(52) U.S. Cl. CPC B29C 47/60
USPC 165/87

(57) ABSTRACT

The invention relates to screw (1), comprising a base body (2) which is rotatable around an axis (a), wherein at least one screw thread (3) extends helically around the base body (2), wherein at least one fluid channel (4) is arranged in the screw (1) which fluid channel (4) is designed for conducting a tempered fluid. To allow a better tempering of the good to be processed the invention proposes that the fluid channel (4) is designed as a channel which is machined into the screw thread (3) and runs helically with it, Furthermore, the invention relates to a method for the production of such a screw.

The invention relates to a screw, comprising a base body which is rotatable around an axis, wherein at least one screw thread extends helically around the base body, wherein at least one fluid channel is arranged in the screw which fluid channel is designed for conducting a tempered fluid. Furthermore, the invention relates to a method for the production of such a screw.

Screws of the generic kind are particularly used to transport, to compact and finally to extrude good of different kind. These measures are considered for example at the processing of plastic material. Another relevant application is the pyrolytical converting of a good. The screw rotates within a screw cylinder, wherein on the one hand thermal energy will be inserted by mechanical work into the pyrolysed good; on the other hand thermal energy will also be inserted into the good because a warmed-up fluid, particularly a heated liquid, will be led through the mentioned fluid channel,

At pre-known inside heated screws the feeding of a gaseous or liquid tempering medium occurs by a central bore in the screw base body, i.e. in the screw root and in the screw center respectively, wherein adequate rotary feedthroughs are at hand to supply the rotating, screw from a stationed supply source with the medium, Likewise at a pre-known electrical heating, a heating, element is located in the central bore of the screw. At a burner heating a burning flame will he positioned directly in front of or within the central bore of the screw.

It is disadvantageous at the pre-known solutions, that the possibility of the input of the energy into the good, which has to he converted, is very limited. At the pre-known screws of the generic kind, the thermal low occurs from the tempering medium into the good, which has to be converted, exclusively from the bore in the screw base body, i. e. from the screw root and from the screw center respectively; the thermal transfer occurs thus only from the screw base face and therefore only from small face parts of the screw. The temperature gradient, which comes into existence and is producible respectively in such a way, prevents a steady thermal transfer into the good, which is to he forwarded and which is to be changed physically and/or chemically respectively.

This is particularly disadvantageous at processes, at which the good, which is to he tempered, tends to form deposits on the thread flanks of the screw, whereto it is to he pointed especially to pyrolytical processes. Furthermore it is negative at the solutions at hand, that the efficiency is had in the case of high temperature implementations, which again is disadvantageous especially for pyrolytical processes.

It is the object of the invention to further develop a screw of the kind mentioned in the beginning in such a way, that the mentioned disadvantages will be prevented. Accordingly a screw shall be provided, at which it is possible to introduce heat into the good, which is to be converted, in a more efficient way than before. It shall particularly make it possible, to conduct pyrolytical processes more efficient, at which a great amount of heat must be inserted via the screw into the good, which good has to he converted. An advantageous method for the production of such a screw shall also be proposed.

The solution of this object by the invention is characterized in that the fluid channel is designed as a channel which is machined into the at least one screw thread and runs helically with it.

Thereby, it is preferably provided that the fluid channel extends radially up to a height of the screw thread which is at least 80%, preferably at least 90%, of the outer radius of the screw thread.

The fluid channel is preferably closed in the radial outer region of the screw thread by a closing element, especially by a closure steel sheet. The closing element is thereby preferably welded or soldered on the screw thread.

Beside the fluid channel at least one second channel can be arranged centrically. For its supply with tempered fluid two preferred possibilities are suggested:

The fluid channel can be connected fluidly with the second channel at one single end of the screw, which is remote from the end of the screw, on which end tempered fluid is led into the screw, so that the fluid channel and the second channel can be flown through by a tempered fluid sequentially, that is in series.

Alternatively it is also possible that the fluid channel is connected fluidly with the second channel at both ends of the screw, so that the fluid channel and the second channel can he flown through parallel by a tempered fluid. In this case at least one throttle can be arranged within the second channel, to throttle the flow of tempered fluid through the second channel. Thereby, a controlling is possible to that effect how much fluid flows through the first helical channel. and how much fluid flows through the central second channel.

The method for the production of such a screw comprises the steps:
a) Production of the base body including the formed screw thread;
b) Machining of a fluid Channel into the screw thread, wherein the screw thread runs helically in the screw thread and wherein material of the screw thread is removed from the radially outer side of the screw thread;
c) Closing of the radially outer end region of the screw thread by means of a closing element.

The machining of the fluid channel into the screw thread (according to feature b) takes place preferably by a milling process. Thereby, it is provided specifically beneficially that a miller, preferably a finger miller, which is aligned with its longitudinal axis radially, is guided. axially during rotation of the screw according to the pitch of the screw thread.

After the machining of the helically running channel into a desired radial depth by using the miller, the opening of the channel, which lies radially outwardly, can be closed, for what, for example, a rolled panel sheet will be welded or soldered on. In case of soldering the use of a hard solder is recommended, because the screw is exposed to higher temperatures during operation.

The invention proposal applies thus upon an efficient inner heated (if applicable also inner cooled) screw in particular for the transfer and the extrusion of a good, wherein a high efficiency of the heat transfer (if applicable also coldness transfer) will be reached by the increase of the thermal transfer faces.

Preferred applications are the pyrolytical converting of a good, the synthetic material converting and the conveyance of bulk goods, wherein consequently the proposed screw preferably comes into operation in reactive chemical facilities, plastic processing machines, in conveyance devices with cooling screws and in drying facilities.

The invention concept enables an essential increase of the thermal transfer face between screw and good and therefore a more efficient thermal transfer.

In the drawings embodiments of the invention are depicted. It shows:

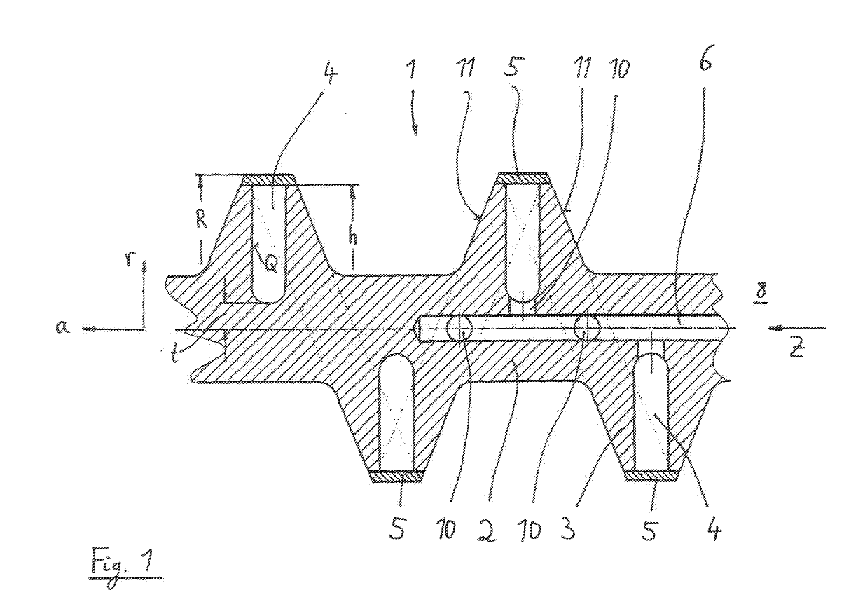

FIG. 1 the radial cross sectional view of a section of a screw which is applied for the pyrolytic converting of a good.

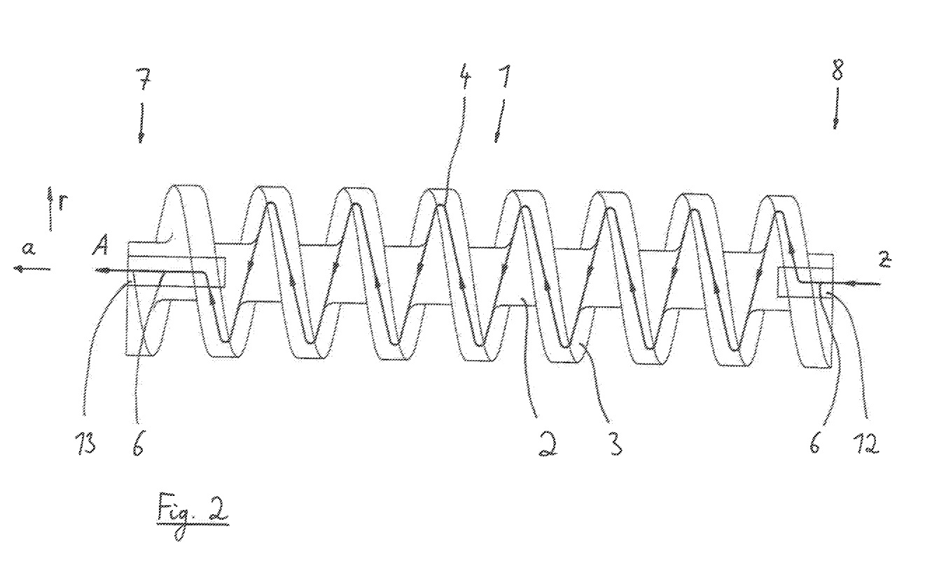

FIG. 2 the side view of the screw through which a temperature control medium is passed through, according to a first possibility of the fluid conduction.

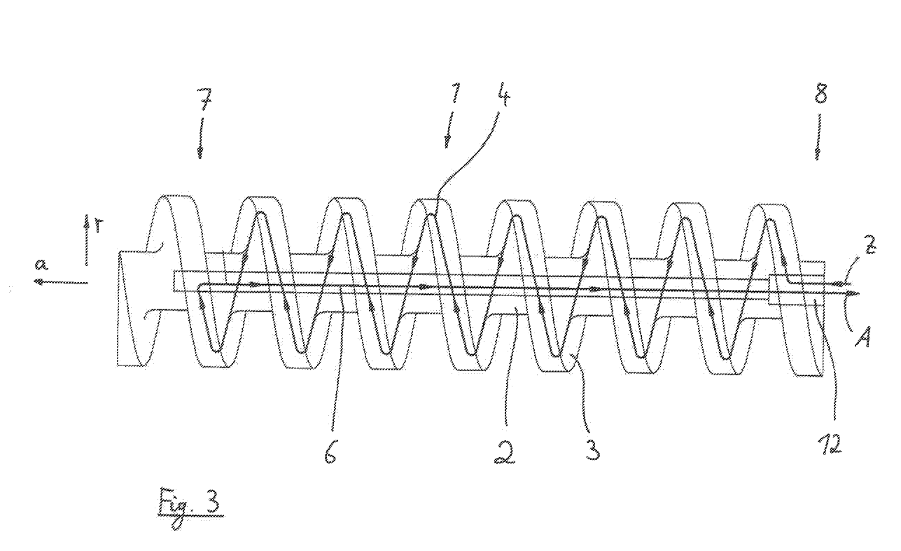

FIG. 3 the side view of a screw according to FIG. 2 according to a second possibility of the fluid conduction and

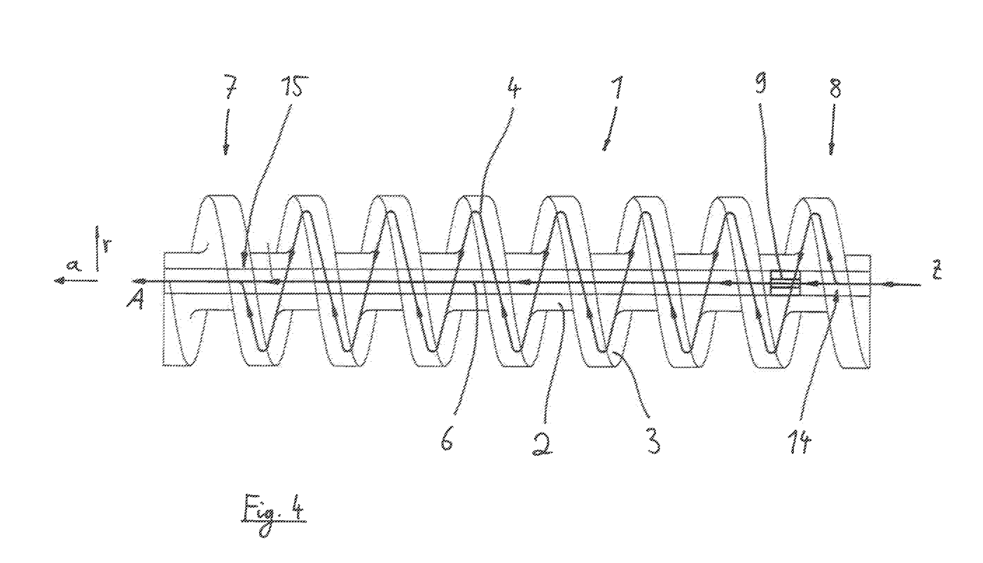

FIG. 4 the side view of a screw according to FIG. 2 according to a third possibility of the fluid conduction.

In FIG. 1 a part of a screw 1 can be seen (and in fact substantially the region close near to one axial end of the screw), which comprises a screw base body 2, on which a screw thread 3 is formed on, which circulates helically around the base body 2 in known manner. The screw thread 3 circulates in doing so in axial direction a around the base body 2.

Depicted is a single thread screw; the concept according to the invention is of course also applicable for a multi-thread screw.

From one end S of the screw 1 tempered (warmed-up) fluid—presently it is a warmed-up liquid is lead to the screw 1 in a direction of fluid feeding Z, in fact into a second channel 6. The second channel 6 is connected fluidly with a fluid channel 4 via three connection bores 10.

The fluid channel 4 is machined into the screw thread 3. Thereby it is provided that a channel with a form of cross section Q—as can be seen in FIG. 1—is milled into the screw thread 3, wherein the fluid channel 4 runs with the same pitch as the screw thread 3. Accordingly, the screw thread 3 comprises along its helically run everywhere the fluid channel 4. It shall be noticed that it is of course not imperative at all, that the fluid channel 4 extends itself along the whole axial length of the screw 1 and of the screw thread 3 respectively; also sections of the screw thread 3 can be provided, which are free from the fluid channel 4.

The form of cross section Q can of course be adjusted to the actual needs, In doing so a form can particularly be advantageous, which widens to the inner radial. direction, to have, if applicable, a constant wall thickness to the flank 11, The machining of the fluid channel 4 is in this case, of course, more complex.

In the radial outer area of the screw thread 3 the channel 4 is closed by a closing element 5. Hereby, it can be a rolled steel sheet, which is put onto the (milled out) screw thread 3 from the outside and. is then welded or soldered on the same, it is also possible that a pipe is pushed onto the screw 1, which pipe will be welded in the area of the radial outer ends of the screw thread 3; the part of the pipe which is not needed can then be removed (cut out).

As can be seen, the fluid channel 4 extends itself up to a depth t in the screw thread 3 radially towards the inside, Further the height h is denoted, up to which the fluid channel 4 extends itself radially towards the outside. For the depth t a value has proven itself, which is between 10 and 30% of the outer radius R of the screw thread 3. Meanwhile a value for the height h is preferably previewed, which value is at least 80% of the outer radius R of the screw thread 3; in the embodiment the height h lies at approximately 93% of the outer radius R.

After that the tempered fluid has been lead into the direction of fluid feeding Z via the second channel 6, it thus arrives via the connection bores 10 into the helically running fluid channel 4 in the screw thread 3 and is therefore able to temper efficiently the flanks 11. of the screw thread 3, i, e. to heat them in the present case.

This basic principle is depicted once more schematically in FIG. 2. The tempered fluid is lead centrally at the end 8 of the screw 1 into the direction of fluid feeding Z via a rotary feedthrough 12 of the screw 1 and namely a short piece of the second channel 6. After the kind. as it is depicted. in FIG. 1, the tempered fluid gets into the fluid channel 4, to flow helically in the screw thread 3. At the end 7 of the screw 1 the tempered fluid. leaves the screw again in an analog way, which fluid has now given heat to the good, which is conveyed by the screw 1, via the flanks 11 of the screw thread 3, wherein again a short piece of the channel 6 and a rotary feedthrough. 13 is provided. The fluid flows off in the direction of fluid discharge A.

At the solution according to FIG. 3 another fluid guide is provided. The tempered fluid gets again into the screw 1 at the end 8 of the screw in direction of fluid feeding Z via a rotary feedthrough 12. Across a short piece of a second channel 6 the fluid gets—as depicted in FIG. 1—into the helical running fluid channel 4, to circulate helically in axial direction a of the screw and to transfer heat via the flanks 11 of the screw thread 3. At the end 7 of the screw 1 the helical circulating fluid channel 4 merges into a second channel 6, which channel runs centrally through the whole screw 1, as it results from FIG. 3. The fluid flows now in the channel 6 in the opposite direction back to the end 8 of the screw 1 and leaves it via the rotary feedthrough 12 into direction of fluid discharge A. According to this embodiment of the invention the central second channel 6 is thus available as it is in the state of the art for the transfer of heat from the tempered fluid to good to he conveyed.

A further alternative fluid guide is depicted in FIG. 4. Here the fluid gets at the end 8 of the screw into the direction of fluid feeding Z into the screw. The central arranged second channel 6 furcates at the junction location 14 and runs at one hand centrally in the inner of the screw 1; furthermore, at the junction location 14 starts the helical circulating fluid channel 4 according to FIG. 1 in the depicted way. At the end 7 of the screw 1 the helical circulating fluid channel 4 and the central second channel 6 are lead together again at the confluence location 15; from here the fluid leaves the screw 1 into direction of fluid discharge A through the central second channel 6.

So that the proportion of the fluid which flows at one hand in the central second channel 6 and at the other hand in the helically circulating fluid channel 4 is according to a desired value, an adjustable throttle 9 is arranged in the second channel 6. By adjusting of the cross section of the throttle it can be defined, which volume flow of tempered fluid flows through the fluid channel 4 and which volume flow flows through the second channel 6.

By the use of the (adjustable) flow throttle 9 in the central screw channel the flow proportion between the central screw channel 6 and the helical fluid channel 4 can be adjusted in such a way, that a mathematical proportionality exists between the thermal transfer faces of the screw root and the screw base body respectively and the thermal transfer faces of the screw flanks 11. Also other flow proportions are possible in terms of process technology, e. g. at the use of an outer heating of the entire device,

The screw 1 which is designed as a transport, extruder and compaction screw respectively is thus designed constructively in such a way, that a piece of the central bore (second channel 6) serves as an inlet and an outlet respectively of the heating and cooling medium respectively.

The screw threads are designed in such a way that according to the necessary process technological screw pitch and helix thickness a void (fluid channel 4) is machined, which is closed towards the outside, which void stays in connection to the central bore (second channel 6) if needed.

The transfer face which is available for the heat transfer is thus considerably increased, in comparison to the pre-known solutions, and the possibility for the heat transfer is improved accordingly. It is advantageous, that a very wide temperature application area is possible for the converting of a good.

This makes it in particular possible, to conduct pyrolytical processes with the proposed screw in improved manner, at which processes a very high temperature is needed in the good which has to be converted, which temperature can be produced by a hot tempered fluid, which fluid is guided through the screw. Thus, with the proposed conception a high energy flow can be lead in from the tempered fluid into the good, which has to be processed.

The proposed design of a screw 1 has proved, itself in particular as advantageous for the transport of thermo oils, salt solutions as a liquid sorbent and similar liquids; the same applies for the transport of gaseous media. Here, temperatures of up to above 500° C. can be realized with a high efficiency, wherein a very equal thermal distribution is possible across the whole machine part surface. This again is particularly advantageous for screws in pyrolytical installations.

The proposed screw can of course he used in any kind of devices, in single screw as well as in multi screw apparatuses.

The screw rotation affects a very good movability of the thermal carrier in the screw threads. Thereby, the proposed concept is adequate for the use of the most multifaceted thermal media, without appearances of stagnations. Therefore many variations are possible at the constructive design of the fluid channels 4.

It is important for pyrolytical applications to keep the good, which has to be converted, under oxygen seal at least temporary. This requirement can be fulfilled with the proposed solution without any problems.

### LIST OF REFERENCES

1 Screw

2 Base body

3 Screw thread

4 Fluid channel

5 Closing element

6 Second channel

7 End of screw

8 End of screw

9 Throttle

10 Connection bore

11 Flank

12 Rotary feedthrough

13 Rotary feedthrough

14 Junction location

15 Confluence location.

a Axial direction/Axis

r Radial direction

h Height

t Depth

R Outer radius

Z Direction of fluid feeding

A Direction of fluid discharge

Q Form of cross section

1-10. (canceled)

11. Screw, comprising:
a base body which is rotatable around an axis;
at least one screw thread extends helically around the base body;
at least one fluid channel is arranged in the screw which is designed for conducting a tempered fluid and which is designed as a channel which is machined into the at least one screw thread and runs helically with the at least one screw thread;
at least one second channel is arranged centrically, the fluid channel is connected fluidly with the second channel at both ends of the screw, the fluid channel and the second channel separate from another at a junction location at one end of the screw and merge again at a confluence location at the other end of the screw, so that the fluid channel and the second channel can be parallel flown through by a tempered fluid, in the second channel at least one throttle is arranged to throttle the flow of tempered fluid through the second channel.

12. The screw of claim 11, wherein the fluid channel extends radially up to a height of the screw thread which is at least 80% of the outer radius of the screw thread.

13. The screw of claim 11, wherein the fluid channel is closed in the radial outer region of the screw thread by a closing element.

14. The screw of claim 12, wherein the closing element (5) is welded or soldered on the screw thread.

15. The screw of claim 12, wherein the height is at least 90% of the outer radius of the screw thread.

16. The screw of claim 13, wherein the closing dement is a closure, steel sheet.
